(19) United States
(12) Patent Application Publication
(10) Pub. No.: US 2005/0270558 A1
(43) Pub. Date: Dec. 8, 2005

(54) Network fax

(76) Inventors: Shane Konsella, Star, ID (US); Scott Starks, San Jose, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/852,298

(22) Filed: May 24, 2004

(51) Int. Cl. G06F 15/16; H04N 1/00

(52) U.S. Cl. 358/1.15; 358/400; 709/206; 358/407

(57) ABSTRACT

A receiving machine is identified for a received document associated with a fax number of a destination fax machine. The associated document is sent via a network to the receiving machine in a form facilitating faxing of the associated document to the destination fax machine.

### BACKGROUND

Many entities distribute documents via facsimile (fax) to locations around the world. The documents may originate in one facility, such as a central office. The central office may generate these documents in the performance of centralized bookkeeping to save costs. However, further costs are incurred in the form of long distance charges when the documents are faxed to other locations of the company, suppliers, and customers located around the world.

Prior attempts to reduce long distance costs exploit a printer's ability to receive email as an internet print path. A user can send a fax from a personal computer that traverses a network as an email. The email is ultimately received and printed on a printer. Not all intended recipients may have such printers with that ability, and they are unable to receive the email.

Further alternatives include replacing a sending fax machine with a scanner/multi-function printer (MFP). Such alternatives still send an analog fax, incurring long distance or international phone charges.

Fax to email alternatives provide the sender of a fax with a fax-like experience, but the document is immediately converted to an email which is sent to the recipient's email in-box. However, some users may still only have an analog fax machine, and are not able to receive email.

### BRIEF DESCRIPTION OF THE DRAWINGS

FIG. 1 is a block diagram of system modules according to an example embodiment.

FIG. 2 is a diagram of a system according to an example embodiment.

FIG. 3 is a diagram of a system according to an example embodiment.

FIG. 4 is a flow diagram of a method according to an example embodiment.

### DETAILED DESCRIPTION

In the following description, reference is made to the accompanying drawings that form a part hereof, and in which is shown by way of illustration specific embodiments in which the invention may be practiced. These embodiments are described in sufficient detail to enable those skilled in the art to practice the invention, and it is to be understood that other embodiments may be utilized and that structural, logical, and electrical changes may be made without departing from the scope of the present invention. The following description is, therefore, not to be taken in a limited sense, and the scope of the present invention is defined by the appended claims.

The functions or algorithms described herein are implemented in software or a combination of software and human implemented procedures in one embodiment. The software comprises computer executable instructions stored on computer readable media such as memory or other type of storage devices. The term “computer readable media” is also used to represent carrier waves on which the software is transmitted. Further, such functions correspond to modules, which are software, hardware, firmware, or any combination thereof. Multiple functions are performed in one or more modules as desired, and the embodiments described are merely examples. The software is executed on a digital signal processor, ASIC, microprocessor, or other type of processor operating on a computer system, such as a personal computer, multi-function printer (MFP), which may also include scanning capabilities.

Some embodiments may implement the functions in two or more specific interconnected hardware modules with related control and data signals communicated between and through the modules, or as portions of an application-specific integrated circuit. Thus, the exemplary process flow is applicable to software, firmware, and hardware implementations.

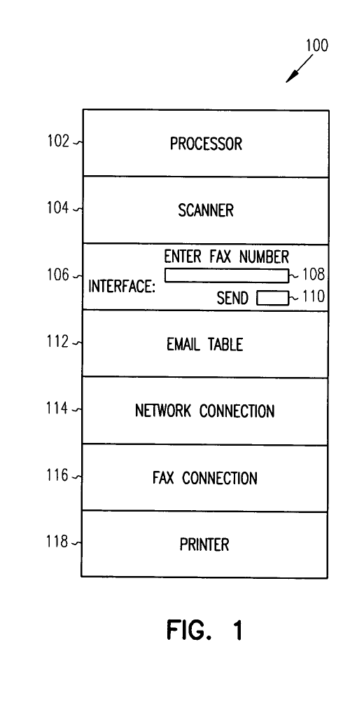

FIG. 1 is an example embodiment of a system 100. The system 100 includes modules for performing various tasks associated with faxing documents. For example, the system 100 includes modules for sending and receiving fax documents over a network to or from a machine having fax sending and/or receiving capabilities. Such system 100 embodiments are useful in minimizing long distance and international call charges by electronically sending documents over a computer network to a fax capable device for less costly faxing to a desired destination while providing an analog fax-like experience.

The system 100 includes a processor module 102, an optional scanner module 104, and an interface module 106. Some embodiments further include an email table module 112, a network connection module 114, a fax connection module 116, and a printer module 118.

The processor module 102 of the system 100 embodiment of FIG. 1 represents a digital signal processor or processing unit of any type of architecture, such as an ASIC (Application-Specific Integrated Circuit), a CISC (Complex Instruction Set Computing), RISC (Reduced Instruction Set Computing), VLIW (Very Long Instruction Word), or hybrid architecture, although any appropriate processor may be used. The processor module 102 executes instructions. The processor module 102 also includes a control unit that organizes data and program storage in memory (not shown) and transfers data and other information in and out of the system 100 and to and from the network connection 114 and fax connection 116.

In some embodiments, the processor module 102 executes instructions for causing the system 100 to operate to provide an analog fax-like user experience. These instructions cause the system 100 to receive, through the interface module 108, a fax number of a destination fax machine and a document for faxing to the destination fax machine through the scanner module 104. These instructions further cause the system 100 to identify and retrieve an email address for the destination fax machine using the email table module 112.

If the email address of the destination fax machine is obtained, the instructions cause the system to send the document over the network connection module 114 to the destination fax machine as an email or other electronic transfer means. The destination fax machine, upon receipt of the email, handles the email as a typically received fax.

However, if an entry for the destination fax machine does not exist in the email table module 112, the instructions cause the system 100 to select a machine having an entry in the email table module 112 to receive the emailed fax for forwarding to the destination fax machine over a fax connection such as a connection to a public switched telephone network (PSTN). In some embodiments, the machine selected to receive the emailed fax for forwarding onto the destination fax machine is selected to minimize long-distance or international calling charges. In this embodiment, the email table contains a representation of the amount of calling charges, rate of charges or an estimate thereof, from the receiving machine to the destination fax machine. The receiving machine associated with the minimum amount is selected to receive the emailed fax.

The optional scanner module 104 represents a document scanner. In some such embodiments, the scanner module 104 is a flatbed scanner, while in other embodiments the scanner is a sheet-feed scanner. The scanner module 104 includes an optical element for sampling a document into an electronic form for transmission as an analog fax or a digital imaging form for attachment to an email or other electronic transfer means.

The interface module 106 includes an input 108 for entering a fax number and a send button 110. Various other embodiments of the interface module 106 include buttons for entering a fax number or email address, selecting a speed-dial number, a key board, a touch screen, or other buttons and displays useful in the operation of a fax machine, a multi-function printer (MFP), a personal computer, a fax capable machine or device, or other similar device.

The email table module 112 holds fax numbers of fax enabled machines and devices and an email address associated with each machine or device. In some embodiments, the email table module 112 includes a table within the email table module 112 on the system 100 that may be specific to the system 100. In some other embodiments, the email table module 112 includes accessing a table stored on a network accessible by the email table module through the network connection module 114. In other embodiments, the email table is stored and shared between a personal computer and a MFP that are functionally connected to one another. In some such embodiments, a country code of the fax number is used as an index into the email table module 112. In some other embodiments, an area code of the fax number is used as an index into the email table module 112.

In some embodiments, the network connection module 114 includes a connection to the Internet. In other embodiments, the network connection module 114 includes a connection to a wide-area network (WAN), a virtual-private network (VPN), or virtually any other network type with local to global reach. The network connection module 114 includes connecting to one of the various network types over a wired or a wireless connection.

The fax connection module 116 includes a connection to a PSTN and/or a private telephone network. Other embodiments include connections to one or more telephone network types.

In some embodiments, the printer module 118 includes a laser or an ink jet printing device. Various other embodiments of the printer module 118 include thermal, impact, and other similar printing devices.

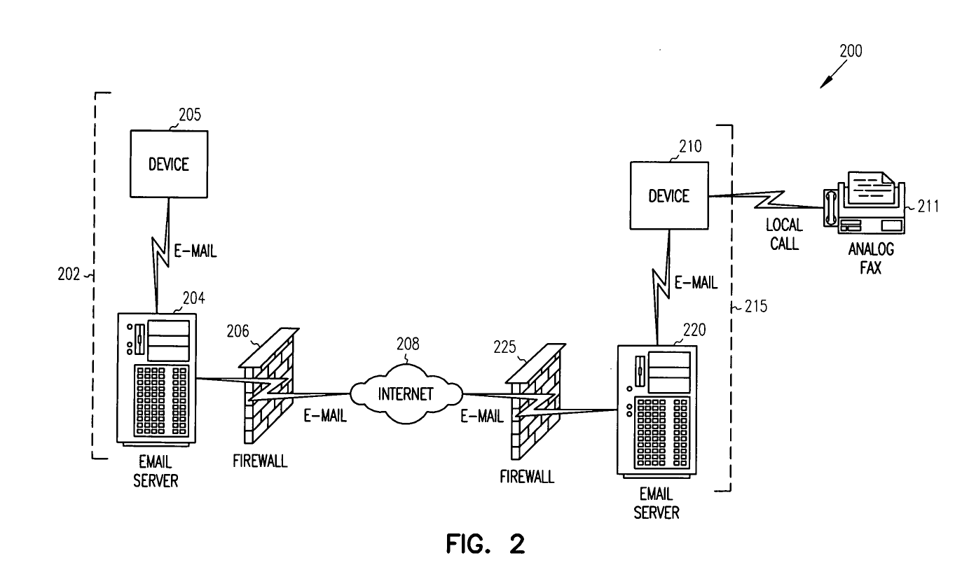

FIG. 2 is an example embodiment of a system 200 implementing two devices (205 and 210). In some embodiments, both devices 205 and 210 are multi-function printers (MFP) having at least the capabilities for scanning, printing, and faxing. In other embodiments, one or both of the devices 205 and 210 are computing devices, such as a personal computer, having the ability to generate and communicate documents over a network, such as the internet. In yet further embodiments, one or both of the devices 205 and 210 include a personal computer connected to a MFP.

The device 205 of the system 200 includes its network connection 114 (as shown in FIG. 1) connected to a local area network 202. The local area network 202 includes an email server 204, a firewall 206, and a connection to one or more external computing networks such as the Internet 208. The firewall 206 protects the local area network 204 from various threats from the one or more external networks such as the Internet 208, while allowing network traffic, such as email, to flow to and from the Internet 208.

The second device 210 of the system 200 also includes its network connection 114 (as shown in FIG. 1) connected to a local area network 215. The local area network 215 includes an email server 220, a firewall 225, and a connection to one or more external computing networks such as the Internet 208. The firewall 225 protects the local area network from various threats from the one or more external networks such as the Internet while allowing network traffic, such as email, to flow to and from the Internet 208. The second device 210 further includes a fax/modem for communicating over a PSTN. The fax/modem enables the second device to make a fax connection 116 (as shown in FIG. 1) over a PSTN, for sending faxes to other fax capable devices such as an analog fax machine 211.

In one embodiment, the system 200 operates by the first device 205 receiving a fax number of a destination fax machine and an associated document. In this embodiment, the destination fax machine is analog fax machine 211. In various embodiments, receiving an associated document includes scanning a document with the scanner module 104 (as shown in FIG. 1) or selecting a document, such as one or more word processing documents or images, from a local or network storage location using the interface module 106 (as shown in FIG. 1).

To route the associated document, the first device 205 identifies another device capable of sending the associated document to the destination fax machine 211 in a fashion so as to minimize long distance charges. In some embodiments the other device is identified as a function of the fax number of the destination fax machine. For example, a portion of the fax number, such as an area code or country code, is used to index into the email table module 112 (as shown in FIG. 1) to determine another device for faxing the associated document to the destination fax machine 211.

Once another device, such as the second device 210 is identified as the device for faxing the associated document the destination fax machine 211, the first device 205 assembles an email including the fax number and the associated document. The first device 205 then sends the assembled email to the second device 210. The email is then communicated from the first device 205 to the first email server 204, across the first firewall 206 to the Internet 208 and across the second firewall 225 to the second email server 220, from which the second device 210 obtains the email.

In some embodiments, the second device 210, upon receipt of the email from the first device 205, dials the fax number of the destination fax machine 211 and transmits the associated document. Upon transmission completion the second device 210 sends an email back to the first device 205 including a fax transmission receipt. The fax transmission receipt includes one or more properties about the transmission. The one or more properties include a number of pages transmitted, an indicator of transmission success or failure, a transmission time, and various other properties associated with transmitting documents via fax.

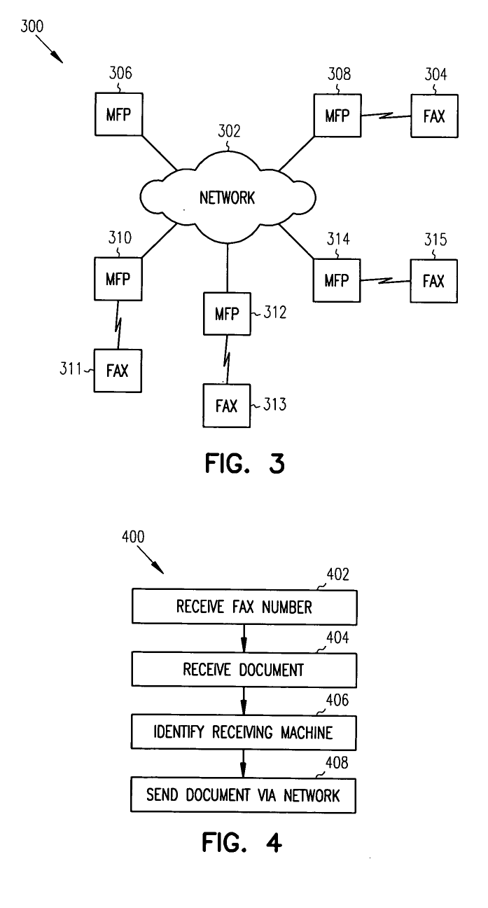

FIG. 3 is an example embodiment of a system 300. In this embodiment, the system 300 includes a plurality of multi-function printers (306, 308, 310, 312, and 314) operably interconnected on network 302. In some embodiments, one or more of the multi-function printers (306, 308, 310, 312, and 314) include a connection to a PSTN and an email table module 112 (as shown in FIG. 1). Multi-function printers 308, 310, 312, and 314 are local to fax machines 304, 311, 313, and 315 respectively.

The system 300 operates, for example, by receiving a destination fax number and associated document at MFP 306. In this instance, the destination fax number is for destination fax machine 315. The email table module 112 of MFP 306 contains entries for MFPs 308, 310, and 312 only. Thus, the email table module 112 of MFP 306 makes a determination, that having MFP 312 fax the associated document to the destination fax machine 315 would best reduce associated long distance charges. The MFP 306 then assembles and sends an email to MFP 312, the email including the destination fax number and associated document.

The MFP 312, upon receipt of the email, makes its own determination for reducing long distance charges associated sending the fax to the destination fax machine 315. In some embodiments, the email table module 112 of MFP 312 contains entries different from the other MFPs (306, 308, 310, and 314). In this embodiment, the email table module contains an entry, identified by the email table module 112, for MFP 314 which provides for a local call to the destination fax machine 315. The MFP 312 thus forwards the email containing the destination fax number and the associated document to MFP 314. MFP 314 then makes a fax connection with the destination fax machine 315 and transmits the associated document.

FIG. 4 is an example embodiment of a method 400. The method 400 includes receiving a fax number 402 corresponding to a destination fax machine, receiving an associated document 404, and identifying a receiving machine 406. Some such embodiments further include sending the associated document via a network 408 to the receiving machine in a form facilitating faxing of the associated document to the destination fax machine.

In some embodiments, receiving a fax number 402 includes a fax number input on a user interface of a device capable of performing the method. The fax number is input by the selection of a function button, such as a speed dial button, on the device capable of performing the method.

In some embodiments of the method 400, identifying a receiving fax machine 406 includes querying a table including email addresses associated with fax number. In some such embodiments, the table is queried using an area code of the received fax number 402. In other embodiments, the table is queried using a country code of the received fax number 402. In some further embodiments, identifying a receiving fax machine 406 includes indexing into the table as a function of the destination fax number.

Sending the associated document via a network 408 includes sending an email over a network. In various embodiments, the network includes a local area network (LAN), a wide area network (WAN), the Internet, a virtual private network (VPN), or virtually any other similar type of network facilitating communication between computer, devices, and other mechanisms capable of communicating over such networks.

1. A computer implemented method comprising:
receiving a fax number corresponding to a destination fax machine;
receiving an associated document;
identifying a receiving machine;
sending the associated document via a network to the receiving machine in a form facilitating faxing of the associated document to the destination fax machine.

2. The method of claim 1 wherein the associated document is sent in the form of an email.

3. The method of claim 1 wherein the network comprises the Internet.

4. The method of claim 1 wherein the computer comprises a personal computer.

5. The method of claim 1 wherein the computer comprises a multi-function printer.

6. The method of claim 5 wherein the receiving machine comprises a multi-function printer.

7. The method of claim 1, wherein the receiving machine is identified as a function of the fax number of the destination fax machine.

8. The method of claim 7 wherein the receiving machine is selected to minimize charges incurred in faxing the associated document to the destination fax machine.

9. The method of claim 8 and further comprising indexing into a table containing email addresses of receiving machines as a function of the fax number, and wherein the associated document is sent in the form of an email.

10. The method of claim 9 wherein a country code of the fax number is used as an index into the table.

11. The method of claim 9 wherein an area code of the fax number is used as an index into the table.

12. The method of claim 1 wherein receiving the associated document comprises scanning the associated document.

13. A computer readable medium having instructions stored thereon for causing a multi-function machine to perform a method comprising:
receiving a fax number corresponding to a destination fax machine;
receiving an associated document;
identifying a receiving multi-function machine;
sending the associated document via a network to the receiving multi-function machine in a form facilitating faxing of the associated document to the destination fax machine.

14. The computer readable medium of claim 13 wherein the associated document is sent in the form of an email.

15. The computer readable medium of claim 13 wherein the network comprises the Internet.

16. The computer readable medium of claim 13 wherein the multi-function machines comprise multi-function printers.

17. The computer readable medium of claim 13, wherein the receiving multi-function machine is identified as a function of the fax number of the destination fax machine.

18. The computer readable medium of claim 17 wherein the receiving multi-function machine is selected such that faxing the associated document to the destination fax machine is a local telephone call.

19. A computer implemented method comprising:
receiving a fax number corresponding to a destination fax machine;
scanning an associated document;
identifying an email address of a receiving machine as a function of the fax number;
emailing the associated document via a network to the receiving machine in a form facilitating faxing of the associated document to the destination fax machine, wherein the email includes the fax number, and wherein the receiving machine is located proximate the destination fax machine to reduce telephone charges.

20. The computer implemented method of claim 19 wherein the computer comprises a multi-function printer with scanning and email capability.

21. The computer implemented method of claim 19 wherein the fax number is used as an index into a database containing email addresses of multiple receiving machines at different locations around the world.

22. A multi-function machine comprising:
means for identifying an email address of destination machine as a function of a fax number corresponding to a destination analog fax machine;
means for emailing a document together with the fax number to the destination machine such that the destination machine can fax the document to the destination analog fax machine.

23. A multi-function machine comprising:
a scanner;
a fax machine user interface;
a table of destination machine email addresses searchable by fax number;
an email module to generate an email containing a document obtained by the scanner and a fax number obtained via the user interface; and
a network connection that sends the email to a destination machine identified from the table, wherein the email facilitates further faxing to a destination fax machine corresponding to the fax number.

24. The multi-function fax machine of claim 23 and further comprising a fax module that sends analog faxes over a telephone connection.

25. The multi-function fax machine of claim 24 wherein the network connection receives emails over the network from other multi-function machines.

26. A system comprising:
a plurality of multi-function printers, each multi-function printer comprising:
a scanner;
a fax machine user interface;
a table of multi-function machine email addresses searchable by fax number;
an email module that generates an email containing a document obtained by the scanner and a fax number obtained via the user interface; and
a network connection that receives email from and sends email to other multi-function printers identified from the table, wherein the email facilitates further faxing to a destination fax machine corresponding to the fax number.

27. The system of claim 26 wherein the network connection comprises an Internet connection.

28. The system of claim 26, wherein each of the plurality of multi-function printers further comprise a fax module that sends analog faxes over a telephone connection.

29. The system of claim 26, wherein the table of each of the plurality of multi-function printers are specific to each such printer.

30. The system of claim 26, wherein the table is shared amongst all of the plurality of multi-function printers.
